(19) United States
(12) Patent Application Publication
(10) Pub. No.: US 2005/0206758 A1
(43) Pub. Date: Sep. 22, 2005

(54) Image sensing device employing CCD pixel compression technique and method for driving the same

(75) Inventors: Takayuki Kaida, Anpachi-gun (JP); Masahiro Oda, Itami-City (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 11/074,667

(22) Filed: Mar. 9, 2005

(30) Foreign Application Priority Data
Mar. 16, 2004 (JP) 2004-073817
Mar. 19, 2004 (JP) 2004-081003
Feb. 18, 2005 (JP) 2005-042865

(51) Int. Cl. H04N 3/14

(52) U.S. Cl. 348/294

(57) ABSTRACT

A conventional image sensing device allowed significant amounts of unwanted electrons to flow upon pixel mixture, thereby providing a low transfer efficiency. An image sensing device has an image sensing section in which multiple light-receiving pixels for converting incident light into information charge for storage during an image sensing period are disposed in rows and columns in a light-receiving region on a semiconductor substrate. A storage section temporarily stores information charge that has been vertically transferred from the image sensing section. A horizontal transfer section vertically transfers row by row the information charges accumulated in the storage section. A driving section provides vertical transfer control. The driving section provides control such that information charge in any of the multiple light-receiving pixels included in the image sensing section is dumped to the semiconductor substrate over an entire image sensing period and pixels are mixed in two or more light-receiving pixels during charge transfer.

### BACKGROUND OF THE INVENTION

1. Field of the Invention

The present invention relates to an image sensing device, and more particularly to a CCD pixel compression technique.

2. Description of the Related Art

In general, digital cameras display previews on the liquid crystal display screen until the shutter button is fully depressed when a picture is taken. Since these previews are often moving images which represent a moving subject, the subject image has to be captured at high rates. Recently, most CCD (Charge Coupled Device) digital cameras have more than one million pixels and thus require accordingly increased operation frequencies in order to output the electrons in all the pixels.

In this context, conventionally known is a technique by which part of electrons produced by photoelectric conversion in a plurality of pixels included in the image sensing section is dumped to a substrate upon pixel mixture in the storage section during charge transfer, thereby implementing pixel compression (e.g., see “Sensitivity improvement in progressive-scan FT-CCDs for digital still camera applications,” IEEE Journal, 2000, by Harry J. van Kujik et al.). When electrons in a certain pixel in the storage section are dumped to the substrate, it is necessary to turn off the pixels vertically adjacent to the pixel. However, the pixels to be turned off are controlled in sync with other pixels disposed at intervals of certain pixels, thereby causing an unwanted on and off operation to be performed on the entire storage section. On the other hand, during the charge transfer in the storage section, a flow of unwanted electrons produced upon pixel mixture also occurs in a number of other pixels which are controlled in sync with the pixel. This results in a decrease in transfer efficiency across the entire storage section.

### SUMMARY OF THE INVENTION

The present invention was developed in view of the aforementioned problems. It is therefore an object of the invention to provide an image sensing device which can dump the information charge of a particular pixel while maintaining the efficiency of transferring the information charge.

To solve the aforementioned problems, an image sensing device according to an aspect of the present invention comprises: an image sensing section which has a plurality of light-receiving pixels for converting incident light into information charge for storage during an image sensing period, the light-receiving pixels being disposed in rows and columns within a light-receiving region on a semiconductor substrate; and a driving section which provides control such that information charge in at least one of the plurality of light-receiving pixels included in the image sensing section is dumped to the semiconductor substrate over an entire image sensing period, and that two or more of the plurality of light-receiving pixels are subjected to pixel mixture. As used herein, the phrase “entire period” is meant to represent the duration from the start to the end of sensing a screenful of image, also substantially including a corresponding duration from the start to the end of the image sensing.

According to this aspect, a particular light-receiving pixel is turned off over an entire image sensing period. Thus, the light-receiving pixel that is turned off accumulates no information charges, e.g., no electrons, which would be otherwise produced by photoelectric conversion to be accumulated therein. In this manner, information charge can be dumped from a particular light-receiving pixel during an image sensing period for efficient pixel mixture. This allows a flow of unwanted information charge to be less prone to being produced upon pixel mixture and thus makes it possible to maintain a good transfer efficiency.

Another aspect of the present invention provides a method for driving an image sensing device. This method includes: providing control such that information charge in at least one of a plurality of light-receiving pixels included in an image sensing section is dumped to a semiconductor substrate over an entire image sensing period; and providing control such that two or more of the plurality of light-receiving pixels are subjected to pixel mixture.

According to this aspect, information charge produced by photoelectric conversion over an entire image sensing period is also dumped from a particular light-receiving pixel. This makes it possible to provide efficient pixel mixture and allows a flow of unwanted information charge to be less prone to being produced upon pixel mixture, thereby allowing for maintaining a good transfer efficiency.

Incidentally, any combinations of the foregoing components, and the components and expressions of the present invention mutually replaced with methods, apparatuses, systems, and the like are also intended to constitute applicable aspects of the present invention.

As described above, the present invention makes it possible to maintain a good information charge transfer efficiency in an image sensing device.

### BRIEF DESCRIPTION OF THE DRAWINGS

FIG. 1 is a view showing the configuration of a CCD in an image sensing device according to a first embodiment;

FIG. 2 is an enlarged plan view showing the vicinity of a boundary between an image sensing section and a storage section;,

FIG. 3 is a sectional view showing the configuration of an image sensing section or a storage section;

FIG. 4 is a schematic view showing the state of gate electrodes during an image sensing period in an image sensing section according to the first embodiment;

FIG. 5 is a time chart showing the process of information charge transfer in a typical image sensing device;

FIG. 6 is a time chart showing the process of information charge transfer according to the first embodiment;

FIG. 7 is a schematic view showing the state of gate electrodes during an image sensing period in an image sensing section according to a second embodiment;

FIG. 8 is a time chart showing the process of information charge transfer according to the second embodiment;

FIG. 9 is a view showing the configuration of a CCD in an image sensing device according to a third embodiment;

FIG. 10 is a plan view showing a gate electrode pattern in the vicinity of a boundary between an image sensing section and a storage section according to the third embodiment;

FIG. 11 is a view showing a driving pattern of a clock signal to be applied to each pixel according to the third embodiment;

FIG. 12 shows a profile representing changes in potential on a cross-section of a pixel according to the third embodiment;

FIG. 13 is a view showing the relationship between the amount of output charge and gate area according to the third embodiment;

FIG. 14 is a plan view showing a gate electrode pattern in the vicinity of the boundary between an image sensing section and a storage section according to a fourth embodiment; and

FIG. 15 is a time chart showing the process of information charge transfer according to the fourth embodiment.

### DETAILED DESCRIPTION OF THE INVENTION

[First Embodiment]

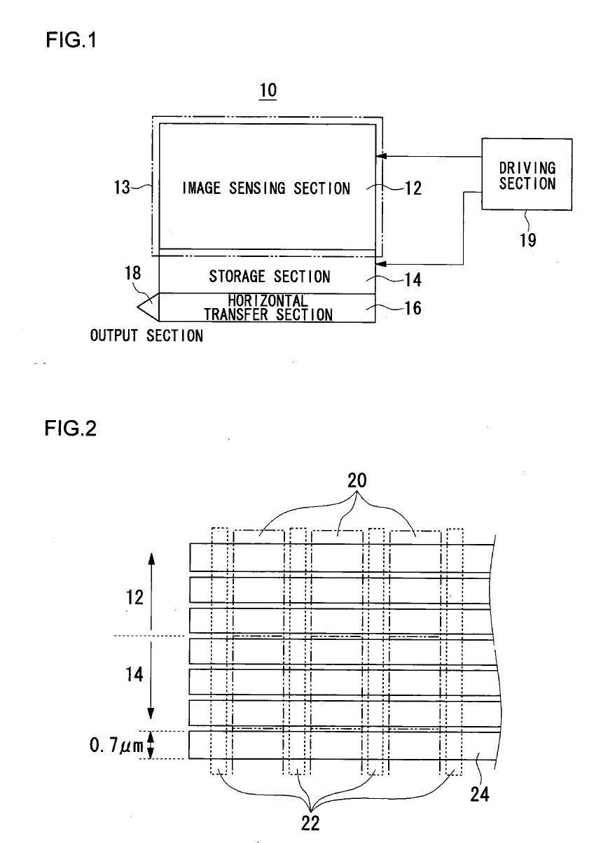

FIG. 1 is a view showing the configuration of a CCD of an image sensing device according to a first embodiment. This figure is a plan view which schematically shows the configuration of an image sensing device 10. The image sensing device 10 includes an image sensing section 12, a storage section 14, a horizontal transfer section 16, an output section 18, and a driving section 19. The image sensing device 10 is a frame transfer type CCD image sensor. The image sensing section 12 includes light-receiving elements for converting incident light into information charge during an image sensing period, and shift registers for accumulating the information charge. The image sensing section 12 is configured such that a plurality of light-receiving pixels, formed of the light-receiving elements and the shift registers, are arranged in rows and columns in the light-receiving region on a semiconductor substrate. There is also provided a color filter 13 on the image sensing section 12.

The storage section 14 is formed such that a plurality of storage pixels are disposed in rows and columns in a masked region on the semiconductor substrate, including shift registers for temporarily accumulating information charge that has been vertically transferred from the image sensing section 12. The number of columns of storage pixels forming the storage section 14 is the same as that of columns of light-receiving pixels forming the image sensing section 12, with the light-receiving pixels and the storage pixels disposed consecutively column by column in the vertical direction. The storage section 14 transfers information charge, which has been temporarily accumulated, to the horizontal transfer section 16 row by row. The horizontal transfer section 16 receives the information charge, which has been accumulated in the storage section 14, row by row for horizontal transfer thereof. The output section 18 outputs the information charge horizontally transferred from the horizontal transfer section 16. The driving section 19 sends a clock signal to the image sensing section 12 and the storage section 14, thereby controlling the vertical transfer of the information charge.

FIG. 2 is an enlarged plan view showing the vicinity of a boundary between the image sensing section and the storage section. As shown, a plurality of gate electrodes 24 are disposed vertically and a plurality of pixel isolation p-type layers 22 are disposed horizontally. The plurality of gate electrodes 24 are divided into a plurality of regions by the pixel isolation p-type layers 22 formed on the substrate (in which the divisions are hereinafter referred to as the “divided regions”), so that three divided regions arranged vertically side by side constitute the gate electrodes for one pixel 20. The plurality of gate electrodes 24 each have a gate length of 0.7 μm and are disposed at intervals of 0.9 μm. The pixels 20 located on the upper side in the figure are light-receiving pixels included in the image sensing section 12, whereas the pixels 20 located on the lower side in the figure are storage pixels included in the storage section 14.

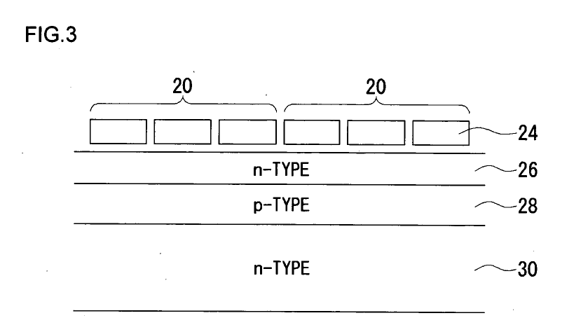

FIG. 3 is a sectional view showing the configuration of the image sensing section or the storage section. As shown, there is formed a p-type layer 28 on an n-type substrate 30, and further thereon formed is an n-type layer 26, thus providing a three-layer structure. The plurality of gate electrodes 24 are disposed on the n-type layer 26, so that three gate electrodes 24 form one pixel 20.

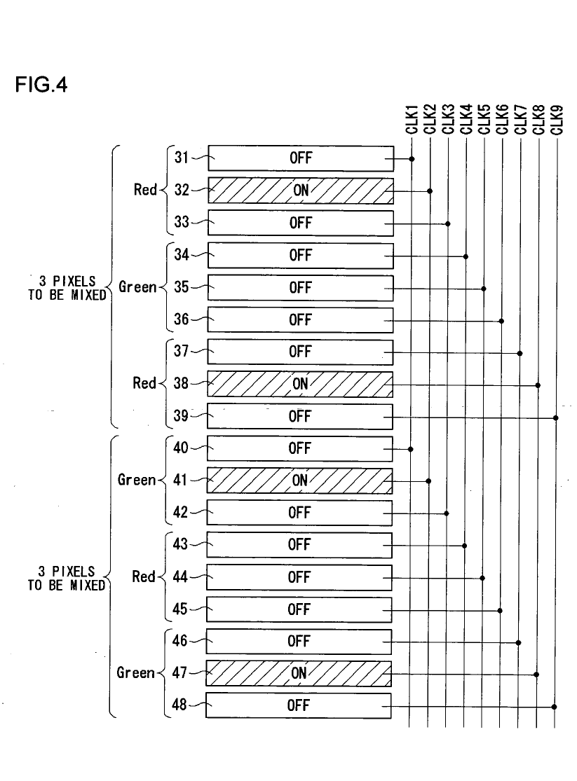

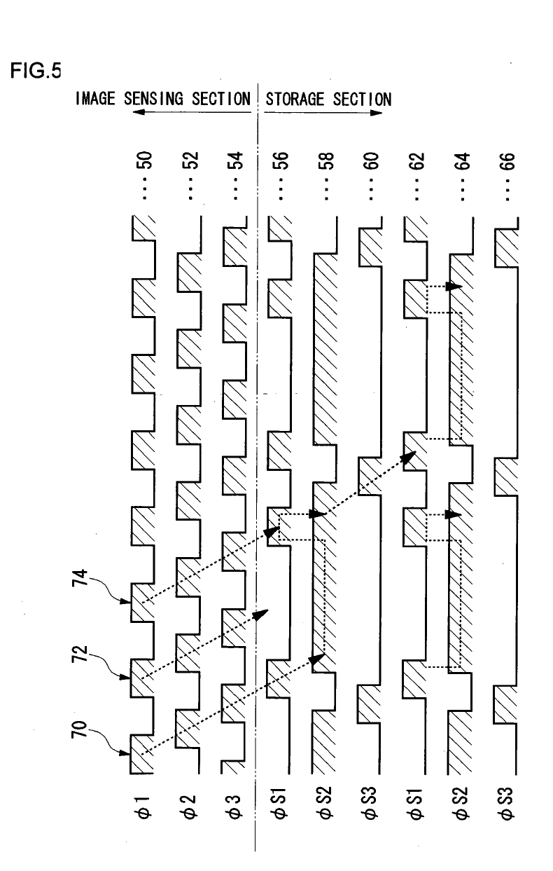

FIG. 4 is a schematic view showing the state of gate electrodes during an image sensing period in the image sensing section according to the first embodiment. In the region shown, vertically arranged are 1st to 18th gate electrodes 31 to 48. Control is provided such that the 1st to 9th gate electrodes 31 to 39 are turned on or off by gate voltages which are sequentially applied as 1st to 9th clock signals CLK1 to CLK9, respectively. Likewise, control is also provided such that the 10th to 18th gate electrodes 40 to 48 are turned on or off by gate voltages which are sequentially applied as the 1st to 9th clock signals CLK1 to CLK9, respectively. The 1st to 9th clock signals CLK1 to CLK9 are applied by means of the driving section 19.

The 1st to 3rd gate electrodes 31 to 33 form one light-receiving pixel corresponding to a red color filter. Likewise, the 7th to 9th gate electrodes 37 to 39 and the 13th to 15th gate electrodes 43 to 45 also form light-receiving pixels corresponding to a red one, respectively. The 4th to 6th gate electrodes 34 to 36, the 10th to 12th gate electrodes 40 to 42, and the 16th to 18th gate electrodes 46 to 48 form light-receiving pixels corresponding to a green one, respectively. In this manner, the light-receiving pixels are disposed in the order of “red—green—red—green—red—green. ” The three pixels located on the upper portion in the figure or the “red—green—red” are subjected to pixel mixture, while the three pixels located on the lower portion in the figure or the “green—red—green” are also subjected to pixel mixture.

Here, a typical image sensing device is adapted such that in an image sensing period, an ON gate voltage is applied to the middle one of the three gate electrodes included in each light-receiving pixel whereas an OFF gate voltage is applied to the other gate electrodes on both sides in the vertical direction. Referring to FIG. 4, an ON gate voltage is typically applied to the 2nd gate electrode 32, the 5th gate electrode 35, the 8th gate electrode 38, the 11th gate electrode 41, the 14th gate electrode 44, and the 17th gate electrode 47. On the other hand, in the image sensing device 10 according to this embodiment, one of the three pixels to be mixed, especially, the middle gate electrode remains off over an entire image sensing period. Referring to FIG. 4, in an image sensing period, the 2nd clock signal CLK2 applies an ON gate voltage to the 2nd gate electrode 32 and the 11th gate electrode 41. The 8th clock signal CLK8 applies a normally ON gate voltage to the 8th gate electrode 38 and the 17th gate electrode 47. Also in the image sensing period, the 5th clock signal CLK5 applies a normally OFF gate voltage to each of the 5th gate electrode 35 and the 14th gate electrode 44. Other clock signals apply a normally OFF gate voltage to other gate electrodes.

This allows information charge produced by conversion of incident light during an image sensing period to be accumulated in the 2nd gate electrode 32, the 8th gate electrode 38, the 11th gate electrode 41, and 17th gate electrode 47. On the other hand, information charge is dumped to the substrate over an entire image sensing period in the other gate electrodes, particularly in the 5th gate electrode 35 and the 14th gate electrode 44. That is, in this embodiment, no electron is accumulated in one of the three pixels or a unit of pixel mixture, thereby causing electrons only in two pixels to be mixed during charge transfer. This makes excess electrons less prone to being dumped to the substrate upon pixel mixture, facilitates pixel compression, and allows for reducing the storage section 14 in size by the amount of compression.

Additionally, those of the three light-receiving pixels, or a unit of pixel mixture, which correspond to a particular color of the color filter 13 convert incident light into information charge for storage during an image sensing period. For the three pixels on the upper side shown in the figure, only the light-receiving pixels corresponding to red accumulate electrons, which are then mixed. For the three pixels on the lower side, on the other hand, only the light-receiving pixels corresponding to green accumulate electrons, which are then mixed. In this manner, in three pixels or a unit of pixel mixture, only those pixels of the same color are mixed with each other and those of different colors are not to be mixed with each other, thereby causing no degradation in color fidelity.

Now, an explanation is given to the process of transferring information charge accumulated in the image sensing section 12 to the storage section 14. First described is the process of information charge transfer in a typical image sensing device and a problem with the process, and then an explanation will be given to the process of information charge transfer in the image sensing device 10 according to this embodiment.

FIG. 5 is a time chart showing the process of information charge transfer in a typical image sensing device. In the figure, there is shown a process of transferring information charge in the order of vertically disposed regions 50, 52, 54, 56, 58, 60, 62, 64, and 66. The regions 50, 52, and 54 are part of the image sensing section, while the regions 56, 58, and 60 are part of the storage section. The chain double-dashed line drawn in between the regions 54 and 56 indicates the boundary between the image sensing section and the storage section.

When a transfer clock signal Φ1 becomes high, information charge 70 moves from a previous region to the region 50. When a transfer clock signal Φ2 becomes high with the transfer clock signal Φ1 in the high state, about half the information charge 70 moves from the region 50 to the region 52. When the transfer clock signal Φ1 becomes low with the transfer clock signal Φ2 in the high state, the remaining half of the information charge 70 moves from the region 50 to the region 52. The clock control like this is repeatedly provided so that the information charge 70 is sequentially transferred in the order of the regions 50, 52, 54, and 56.

When a transfer clock signal ΦS2 becomes high with a transfer clock signal ΦS1 in a high state after the information charge 70 has been transferred to the region 56, about half the information charge 70 moves from the region 56 to the region 58. When the transfer clock signal ΦS1 becomes low with the transfer clock signal ΦS2 in the high state, the remaining half of the information charge 70 moves from the region 56 to the region 58. The transfer clock signal ΦS2 remains high until information charge 74 to be subjected to pixel mixture is transferred to the 5th region 58. When the transfer clock signal ΦS1 becomes high with the transfer clock signals Φ3 and ΦS2 in the high state, electrons start to flow from the region 54 to the region 58. Subsequently, when the transfer clock signals Φ3 and ΦS1 become low with the transfer clock signal ΦS2 remaining in the high state, all the information charge 74 moves to the region 58, causing the information charge 70 and the information charge 74 to be mixed with each other. On the other hand, since the region 56 remains off when information charge 72 has been sequentially transferred to the regions 50, 52, and 54, the information charge 72 is dumped from the region 54 to the substrate when the transfer clock signal Φ3 becomes low.

Here, when the transfer clock signal ΦS1 becomes high with the transfer clock signal ΦS2 in the high state, the mixture of the information charge 70 with the information charge 74 would cause a flow of unwanted electrons to occur between the regions 56 and 58. In the storage section 14, since the same transfer clock signal is synchronously applied to every three regions, a flow of unwanted electrons produced between the regions 56 and 58 will also occur every three regions such as between the regions 62 and 64. Accordingly, a similar flow of unwanted electrons will occur throughout the storage section 14, causing degradation in transfer efficiency.

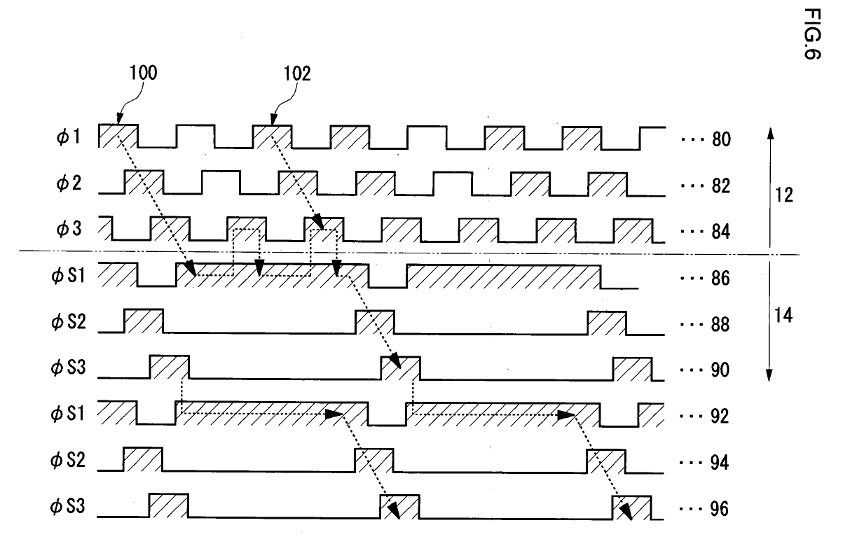

FIG. 6 is a time chart showing the process of information charge transfer according to the first embodiment. In this figure, there is shown a process of transferring information charge in the order of vertically disposed 1st region 80, 2nd region 82, 3rd region 84, 4th region 86, 5th region 88, 6th region 90, 7th region 92, 8th region 94, and 9th region 96. The 1st region 80, the 2nd region 82, and the 3rd region 84 are part of the image sensing section 12, while the 4th region 86, the 5th region 88, and the 6th region 90 are part of the storage section 14. The chain double-dashed line drawn between the 3rd region 84 and the 4th region 86 indicates the boundary between the image sensing section 12 and the storage section 14. The driving section 19 applies to each region the 1st transfer clock signal Φ1, the 2nd transfer clock signal Φ2, the 3rd transfer clock signal Φ3, the 4th transfer clock signal ΦS1, the 5th transfer clock signal ΦS2, and the 6th transfer clock signal ΦS3.

When the 1st transfer clock signal Φ1 becomes high, information charge 100 moves from a previous region to the 1st region 80. When the 2nd transfer clock signal Φ2 becomes high with the 1st transfer clock signal Φ1 in the high state, about half the information charge 100 moves from the 1st region 80 to the 2nd region 82. When the 1st transfer clock signal Φ1 becomes low with the 2nd transfer clock signal Φ2 in the high state, the remaining half of the information charge 100 moves from the 1st region 80 to the 2nd region 82. Such clock control is repeated, thereby allowing the information charge 100 to be transferred in the order of the 1st region 80, the 2nd region 82, the 3rd region 84, and the 4th region 86.

In this embodiment, electrons are dumped from a particular pixel in the image sensing section 12 during an image sensing period, thereby eliminating the need to purge pixels at the boundary between the image sensing section 12 and the storage section 14 during charge transfer.

Accordingly, pixel mixture or here the pixel mixture between the information charge 100 and information charge 102 occurs at the boundary between the image sensing section 12 and the storage section 14, i.e., between the 3rd region 84 and the 4th region 86. The 4th transfer clock signal ΦS1 is kept high until the information charge 100 and the information charge 102 are mixed after the information charge 100 has been transferred to the 4th region 86. While the 4th transfer clock signal ΦS1 is kept high, the 3rd transfer clock signal Φ3 becomes high twice, thereby causing a flow of unwanted electrons to occur between the 3rd region 84 and the 4th region 86. However, the 6th transfer clock signal ΦS3, which is not in sync with the 3rd transfer clock signal Φ3, is applied to the 6th region 90 located at the third region from the 3rd region 84. Accordingly, the flow of unwanted electrons occurring between the 3rd region 84 and the 4th region 86 will not appear between the 6th region 90 and the 7th region 92, which are each located at the third region therefrom. Thus, a similar flow of electrons will not be repeated throughout the storage section 14. In this manner, this embodiment can reduce the flow of unwanted electrons and thus maintain a good transfer efficiency.

[Second Embodiment]

The image sensing device according to the first embodiment is adapted to dump information charge from only one of three pixels during an image sensing period. An image sensing device according to a second embodiment is different from the one according to the first embodiment in that information charge is dumped from two of the three pixels to the substrate during an image sensing period. Now, the main points of difference between this embodiment and the first embodiment will be described below, with the other commonly shared arrangements not explained repeatedly.

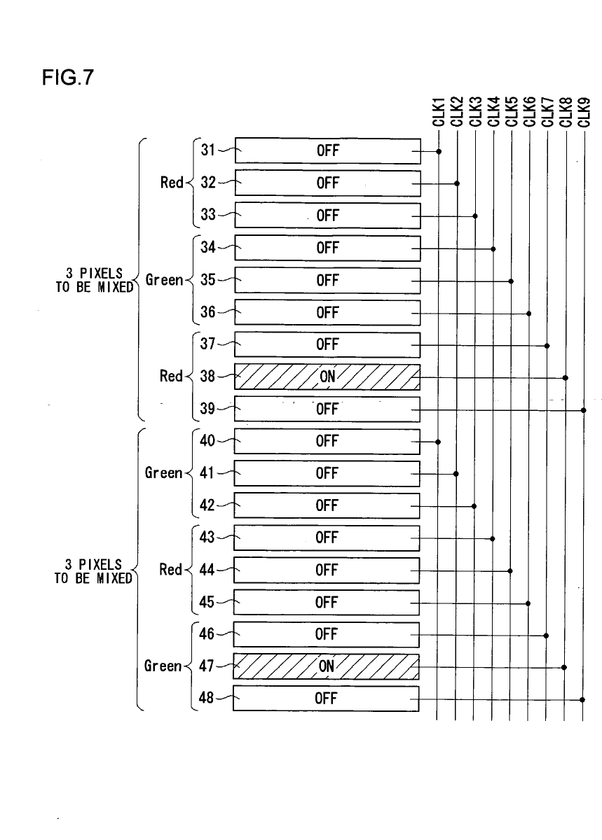

FIG. 7 is a schematic view showing the state of gate electrodes during an image sensing period in the image sensing section according to the second embodiment. Since all pixels are turned on in the image sensing section of a typical image sensing device, an ON gate voltage is applied to the 2nd gate electrode 32, the 5th gate electrode 35, the 8th gate electrode 38, the 11th gate electrode 41, the 14th gate electrode 44, and the 17th gate electrode 47. On the other hand, in the image sensing section 12 of the image sensing device 10 according to this embodiment, only one of three pixels or a unit of pixel mixture is turned on. That is, in an image sensing period, the 8th clock signal CLK8 applies a normally ON gate voltage only to the 8th gate electrode 38 and the 17th gate electrode 47. The 2nd clock signal CLK2 applies a normally OFF gate voltage to other gate electrodes, especially, to the 2nd gate electrode 32 and the 11th gate electrode 41. Additionally, the 5th clock signal CLK5 applies a normally OFF gate voltage to the 5th gate electrode 35 and the 14th gate electrode 44.

This allows information charge produced by converting incident light during an image sensing period to be accumulated in each of the light-receiving pixels that include the 8th gate electrode 38 and the 17th gate electrode 47. On the other hand, in each of the light-receiving pixels including other gate electrodes, especially, the 2nd gate electrode 32, the 5th gate electrode 35, the 11th gate electrode 41, and the 14th gate electrode 44, information charge is dumped to the substrate over an entire image sensing period.

In this embodiment, no electrons are accumulated in two of three pixels or a unit of pixel mixture during an image sensing period. This is substantially equivalent to pixel mixture occurring in the image sensing section 12 during an image sensing section. Accordingly, during charge transfer, no particular pixel mixture operation is required, and thus only the electrons in the one of the three pixels need to be vertically transferred to the storage section 14 as they are. This facilitates pixel compression without excessive electrons being dumped to the substrate due to pixel mixture.

Under a relatively bright condition, a sufficiently bright image could be obtained only by two of the three pixels being purged during an image sensing period for transfer of information charge of only one pixel. It is thus possible to compress pixels while maintaining the quality of image.

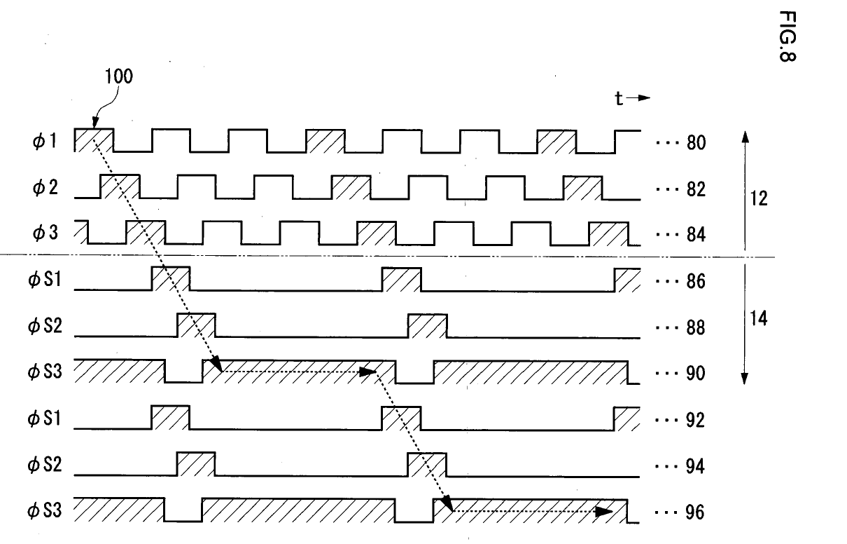

FIG. 8 is a time chart showing the process of information charge transfer according to the second embodiment. In the same manner as in FIG. 6 of the first embodiment, the 10th to 18th regions 80 to 96 are arranged, and the information charge 100 is transferred from the 1st region 80 to the 4th region 86.

After the information charge 100 has been transferred to the 4th region 86, the 4th transfer clock signal ΦS1, the 5th transfer clock signal ΦS2, and the 6th transfer clock signal ΦS3 become sequentially high, allowing the information charge 100 to be transferred from the 4th region 86 to the 6th region 90. To transfer the information charge 100, which has been transferred to the 6th region 90, to the next 7th region 92, the 6th transfer clock signal ΦS3 is also kept high until the 4th transfer clock signal ΦS1 applied to the 7th region 92 becomes high. The 4th transfer clock signal ΦS1, the 5th transfer clock signal ΦS2, and the 6th transfer clock signal ΦS3 become sequentially high, allowing the information charge 100 to be transferred from the 6th region 90 to the 9th region 96.

In this embodiment, electrons are dumped from the two of the three pixels or a unit of pixel mixture in the image sensing section 12 during an image sensing period, allowing electrons to be accumulated only in one pixel. Accordingly, during charge transfer, no operation of purging a pixel is required at the boundary between the image sensing section 12 and the storage section 14 or in the storage section 14. Thus, no flow of unwanted electrons between regions will occur which appears in a typical image sensing device or the first embodiment, thereby providing a high transfer efficiency throughout the storage section 14.

[Third and Fourth Embodiments]

Related Art to the Third and Fourth Embodiments

In general, digital cameras display previews on the liquid crystal display screen until the shutter button is fully depressed when a picture is taken. Since these previews are often moving images which represent a moving subject, the subject image has to be captured at high rates. Recently, most CCD (Charge Coupled Device) digital cameras have more than one million pixels and thus require accordingly increased operation frequencies or need to compress pixels in order to output the electrons in all the pixels.
[Patent Document 1] Japanese Patent Laid-Open Publication No. Hei 9-97894
[Patent Document 2] Japanese Patent Laid-Open Publication No. Hei 11-69236
   Problems to be Solved by the Third and Fourth Embodiments

A typical frame transfer type CCD image sensor is adapted such that each pixel has basically the same structure and the same gate area in the image sensing section and the storage section. Accordingly, when pixels are compressed upon capturing a moving image, a plurality of pixels mixed may produce information charge that cannot be accommodated in one channel region. In this case, the excessive information charge may leak into the channel region of other adjacent pixels, thereby causing degradation in image quality of a reproduced image.

The third and fourth embodiments were developed in view of the aforementioned problem. It is therefore an object of the third and fourth embodiments to provide an image sensing device which prevents degradation in image quality caused by information charge leaking into other channel regions.

To solve the aforementioned problem, an image sensing device according to the third and fourth embodiments comprises: an image sensing section which has a plurality of light-receiving pixels for converting incident light into information charge for storage during an image sensing period, the light-receiving pixels being disposed within a light-receiving region on a substrate; a storage section which temporarily stores information charge which is vertical transferred from the image sensing section; and a transfer section which transfers the information charge accumulated in the storage section. The gate area of each pixel included in the storage section is formed to be greater than that of each pixel included in the image sensing section.

Here, the “substrate” may be a semiconductor substrate. The “plurality of light-receiving pixels” may also be arranged in rows and columns in the light-receiving region on the substrate. The “transfer section” may be a horizontal transfer section which horizontally transfers row by row the information charge accumulated in the storage section. For example, the “information charge” may be electrons.

According to an aspect of this embodiment, the gate area of the storage section is larger and thus the channel region under the gate is larger by that amount. This makes information charge less prone to leakage even when pixel mixture in the vicinity of the boundary between the image sensing section and the storage section causes an increase in the amount of information charge to be accumulated in one pixel. It is thus possible to prevent degradation in image quality which may be caused by information charge leaking into the channel region of other adjacent pixels.

According to another aspect of the third and fourth embodiments, also provided is a method for driving an image sensing device. The method comprises: providing control such that incident light is converted into information charge for storage during an image sensing period; providing control such that a potential barrier built between a channel region for generating information charge in each of a plurality of light-receiving pixels for storage and a drain region disposed adjacent to the channel region to absorb excessive information charge is lower than a potential barrier built during an image sensing period; and transferring information charge so that a plurality of pixels are mixed in the vicinity of a boundary between the image sensing section and the storage section.

According to this aspect, during information charge transfer, information charge can be actively dumped from the channel region toward the substrate, thereby limiting the amount of information charge in each pixel. Accordingly, it is possible to restrict an increase in the amount of information charge in advance before pixel mixture in the vicinity of the boundary between the image sensing section and the storage section. It is thus possible to prevent degradation in image quality which may be caused by information charge leaking into the channel region of other adjacent pixels.

Incidentally, any combinations of the foregoing components, and the components and expressions of the third and fourth embodiments mutually replaced with methods, apparatuses, systems, and the like are also intended to constitute applicable aspects of the third and fourth embodiments.

[Third Embodiment]

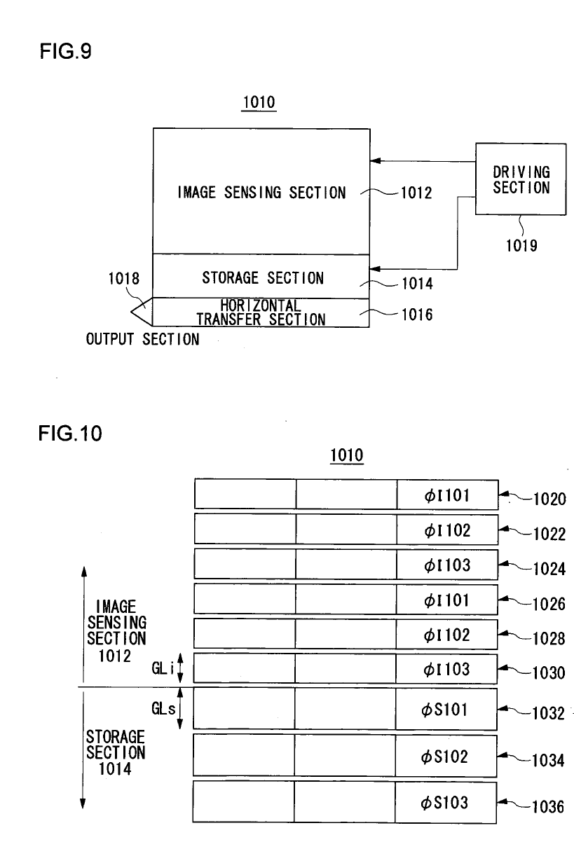

FIG. 9 is a view showing the configuration of a CCD in the image sensing device according to the third embodiment. This figure is a schematic plan view showing the configuration of an image sensing device 1010. The image sensing device 1010 includes an image sensing section 1012, a storage section 1014, a horizontal transfer section 1016, an output section 1018, and a driving section 1019. The image sensing device 1010 is a frame transfer type CCD image sensor. The image sensing section 1012 includes light-receiving elements for converting incident light into information charge during an image sensing period, and shift registers for accumulating the information charge. The image sensing section 1012 is formed such that a plurality of light-receiving pixels, formed of the light-receiving elements and shift registers, are arranged in rows and columns in a light-receiving region on a semiconductor substrate.

The storage section 1014 is formed such that a plurality of storage pixels are disposed in rows and columns in a masked region on a semiconductor substrate, including shift registers for temporarily accumulating information charge that has been vertically transferred from the image sensing section 1012. The number of columns of storage pixels forming the storage section 1014 is the same as that of columns of light-receiving pixels forming the image sensing section 1012, with the light-receiving pixels and the storage pixels disposed consecutively column by column in the vertical direction. The storage section 1014 transfers information charge, which has been temporarily accumulated, to the horizontal transfer section 1016 row by row. The horizontal transfer section 1016 receives the information charge, which is accumulated in the storage section 1014, from the storage section 1014 row by row for horizontal transfer thereof. The output section 1018 outputs the information charge horizontally transferred from the horizontal transfer section 1016. The driving section 1019 sends a clock signal to the image sensing section 1012 and the storage section 1014, thereby controlling the information charge being vertically transferred or dumped to the substrate.

FIG. 10 is a plan view showing a gate electrode pattern in the vicinity of the boundary between the image sensing section and the storage section. As shown, vertically arranged are a 1st gate electrode 1020, 2nd gate electrode 1022, 3rd gate electrode 1024, 4th gate electrode 1026, 5th gate electrode 1028, 6th gate electrode 1030, 7th gate electrode 1032, 8th gate electrode 1034, and 9th gate electrode 1036. These 1st to 9th gate electrodes 1020 to 1036 are each divided into a plurality of regions by pixel isolation p-type layers (in which the divisions are hereinafter referred to as the “divided regions”), so that three divided regions arranged vertically side by side form one pixel. The 1st to 6th gate electrodes 1020 to 1030 are part of the image sensing section 1012, in which three divided regions form one pixel. The 7th to 9th gate electrodes 1032 to 1036 are part of the storage section 1014, in which three divided regions form one pixel.

The driving section 1019 applies clock signals to the 1st to 9th gate electrodes 1020 to 1036, thereby providing control to the operation of accumulating or transferring information charge. A 1st vertical clock signal ΦI101 is applied to the 1st gate electrode 1020 and the 4th gate electrode 1026. A 2nd vertical clock signal ΦI102 is applied to the 2nd gate electrode 1022 and the 5th gate electrode 1028. A 3rd vertical clock signal ΦI103 is applied to the 3rd gate electrode 1024 and the 6th gate electrode 1030. A 1st storage clock signal ΦS101 is applied to the 7th gate electrode 1032. A 2nd storage clock signal ΦS102 is applied to the 8th gate electrode 1034. A 3rd storage clock signal ΦS103 is applied to the 9th gate electrode 1036.

When the 1st to 3rd vertical clock signals ΦI101 to ΦI103 become high in sequence, information charge is sequentially transferred in the order of the 1st to 3rd gate electrodes 1020 to 1024. Furthermore, when the 1st to 3rd vertical clock signals ΦI101 to ΦI103 become high in sequence, information charge is sequentially transferred in the order of the 3rd to 6th gate electrodes 1024 to 1030. Still furthermore, when the 1st to 3rd storage clock signals ΦS101 to ΦS103 become high, pixels are mixed between the 6th gate electrode 1030 and the 7th gate electrode 1032, and then the mixed information charge is transferred in the order of the 7th to 9th gate electrodes 1032 to 1036.

The 7th to 9th gate electrodes 1032 to 1036 included in the storage section 1014 have a gate length GLs which is greater than a gate length GLi of the 1st to 6th gate electrodes 1020 to 1030 included in the image sensing section 1012. That is, since each gate electrode has the same gate width, the 7th to 9th gate electrodes 1032 to 1036 have a gate area greater than that of the 1st to 6th gate electrodes 1020 to 1030. As such, each pixel is configured such that information charge is less prone to leakage because of a larger channel region underlying the gate of each pixel in the storage section 1014 even when pixels are mixed in the vicinity of the boundary between the image sensing section 1012 and the storage section 1014. When the gate length GLs of the 7th to 9th gate electrodes 1032 to 1036 is greater than the gate length GLi of the 1st to 6th gate electrodes 1020 to 1030 at least by one or more times, the information charge mixed is less prone to leakage by that amount. For example, suppose that the gate length GLs is within twice the gate length GLi of the 1st to 6th gate electrodes 1020 to 1030 for two pixels being mixed and the gate length GLs is within three times the gate length GLi of the 1st to 6th gate electrodes 1020 to 1030 for three pixels being mixed. In this case, the information charge mixed is less prone to leakage by that amount.

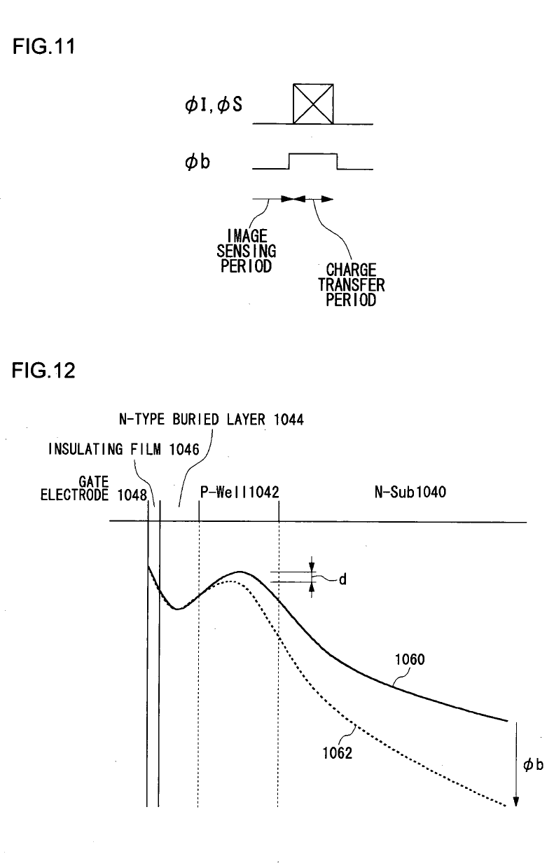

FIG. 11 is a view showing a driving pattern of a clock signal to be applied to each pixel. In a charge transfer period, the driving section 1019 applies a vertical clock signal ΦI or a storage clock signal ΦS to the gate electrode of each pixel as well as applies a substrate clock signal Φb to the drain region of each pixel for a predetermined period. This figure shows the relationship between the vertical clock signal ΦI and the storage clock signal ΦS, and the driving pattern of the substrate clock signal Φb.

In a charge transfer period following an image sensing period, the driving section 1019 causes the substrate clock signal Φb applied to the drain region of each pixel to be high when causing the vertical clock signal ΦI or the storage clock signal ΦS applied to the gate electrode of each pixel to be high. In this manner, information charge may not be totally accommodated in the channel region underlying the gate of each pixel in the storage section 1014 when pixels are mixed in the vicinity of the boundary between the image sensing section 1012 and the storage section 1014. In this case, the information charge is actively allowed to flow into the drain region in advance before the pixel mixture and thus prevented from being leaked into adjacent channel regions. This makes it possible to prevent degradation in image quality which may be caused by information charge leaking into adjacent channel regions.

FIG. 12 shows a profile representing changes in potential on a cross-section of a pixel. The image sensing section 1012 and the storage section 1014 mainly include an N-type semiconductor substrate or an N-substrate region 1040, a P-type diffusion region formed on top thereof or a P-well region 1042, an N-type diffusion layer serving as a channel region formed on top thereof or an N-type buried layer 1044, and an insulating film 1046 and a gate electrode 1048 formed on top thereof.

The vertical clock signal ΦI or the storage clock signal ΦS is applied to the gate electrode 1048, while the substrate clock signal Φb is applied to the N-substrate region 1040.

As shown by a solid curve 1060 in FIG. 12, during an image sensing period, a potential well is formed near the N-type buried layer 1044 and a barrier is also formed near the P-well region 1042. Accordingly, information charge is accumulated in the N-type buried layer 1044 up to the surface of the P-well region 1042.

Here, suppose that the substrate clock signal Φb is increased in amplitude so that the potential on the N-substrate region 1040 side is deepened from the position indicated by the solid curve 1060 down to the position indicated by a short dashed curve 1062 in the figure, thereby reducing the barrier near the P-well region 1042 by a width of d. This causes part of information charge, which would be otherwise accumulated in the potential well near the N-type buried layer 1044, to be dumped toward the N-substrate region 1040 along the gradient indicated by the short dashed curve 1062. Such control is provided to each pixel during a charge transfer period, thereby making it possible to limit the maximum amount of transferred information charge to a reduced one in advance before pixel mixture. Accordingly, when pixels are mixed in the vicinity of the boundary between the image sensing section 1012 and the storage section 1014, it is possible to prevent information charge from overflowing into adjacent pixel channel regions. Additionally, since the gate area of each pixel in the storage section 1014 being greater than that of each pixel in the image sensing section 1012 provides a wider channel region under the gate, information charge is less prone to being leaked into the adjacent channel regions. This makes it possible to prevent degradation in image quality of a reproduced image. Furthermore, the amount of information charge dumped to the drain region and the size of the gate area can be optimized, thereby efficiently preventing degradation in image quality.

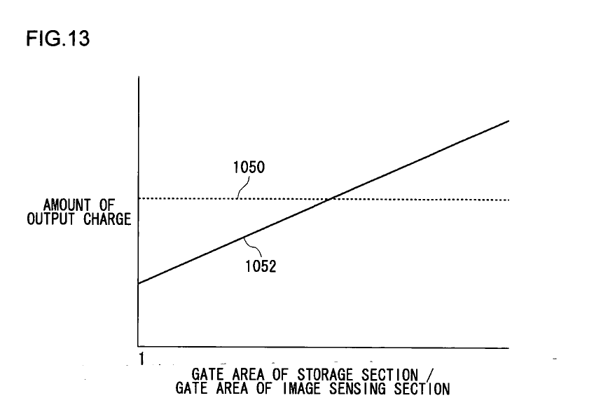

FIG. 13 shows the relationship between the amount of output charge and gate area. Referring to FIG. 13, a short dashed line 1050 shows the relationship between the amount of output charge and the gate area of the storage section 1014 in which pixels are not mixed up to the vicinity of the boundary between the image sensing section 1012 and the storage section 1014 and the substrate clock signal Φb is not increased in amplitude during charge transfer. In the figure, a solid line 1052 shows the relationship between the amount of output charge and the gate area of the storage section 1014 in which pixels are mixed in the vicinity of the boundary between the image sensing section 1012 and the storage section 1014 and the substrate clock signal Φb is increased in amplitude during charge transfer. The substrate clock signal Φb is so set as to prevent degradation in image quality. Here, it is assumed that three pixels are mixed. Pixels are not mixed in the case of still image photography, which is shown by the short dashed line 1050, whereas pixels need to be mixed for pixel compression in the case of moving image photography, which is shown by the solid line 1052.

The left end in the figure indicates the case where the gate area of each pixel included in the storage section 1014 is equal to that of each pixel included in the image sensing section 1012. In this case, the gate area of the storage section 1014 is not large enough for the amount of output charge provided after pixel mixture, by the amount of which the substrate clock signal Φb needs to be increased in amplitude to actively dump information charge to the N-substrate region 1040. Accordingly, the amount of output charge during moving image photography is significantly less than that during still image photography. On the other hand, the right end in the figure shows the case where the gate area of the storage section 1014 is about three times that of the image sensing section 1012. In this case, the gate area of the storage section 1014 is wide enough to provide a sufficient amount of output charge. However, the gate area of the storage section 1014 being too wide for an actual amount of output charge will cause an unnecessary increase in citcuit size.

Referring to FIG. 13, the vicinity of intersection between the short dashed line 1050 and the solid line 1052 shows an ideal relationship between the amount of output charge and the gate area of the storage section 1014, in which the amount of output charge indicated by the solid line 1052 is equal to or substantially equal to the amount of output charge indicated by the short dashed line 1050. That is, it is possible to restrict an increase in gate area to the required minimum while reducing to a minimum the amount of dumped information charge resulting from an increase in amplitude of the substrate clock signal Φb. Based upon such values, it is possible to design the gate area or the gate length of the storage section 1014 and the extent to which the substrate clock signal Φb is increased in amplitude, thereby allowing the amount of output charge and the size of the gate area of the storage section 1014 to be optimally balanced.

[Fourth Embodiment]

The third embodiment provides pixel mixture in the vicinity of the boundary between the image sensing section and the storage section. In relation to pixel mixture, the fourth embodiment is different from the third embodiment in that pixels are mixed in the image sensing section during a charge transfer period to then transfer information charge from the image sensing section to the storage section. Now, this embodiment will be described mainly in relation to the different points from the third embodiment.

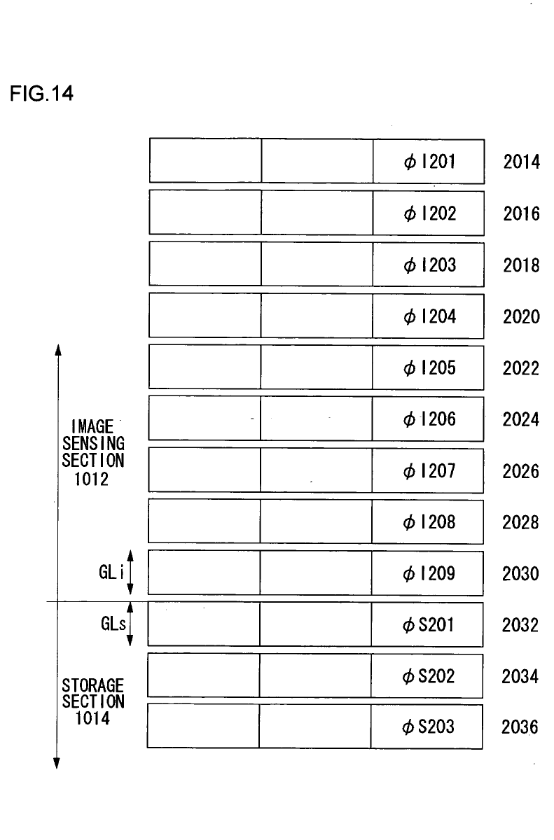

FIG. 14 is a plan view showing a gate electrode pattern in the vicinity of the boundary between the image sensing section and the storage section. As shown, vertically arranged are a 1st gate electrode 2014, 2nd gate electrode 2016, 3rd gate electrode 2018, 4th gate electrode 2020, 5th gate electrode 2022, 6th gate electrode 2024, 7th gate electrode 2026, 8th gate electrode 2028, and 9th gate electrode 2030, 10th gate electrode 2032, 11th gate electrode 2034, and 12th gate electrode 2036. These 1st to 12th gate electrodes 2014 to 2036 are divided into a plurality of regions by pixel isolation p-type layers, respectively, so that three divided regions arranged vertically side by side form one pixel. The 1st to 9th gate electrodes 2014 to 2030 are part of the image sensing section 1012, in which three divided regions form one light-receiving pixel. The 10th to 12th gate electrodes 2032 to 2036 are part of the storage section 1014, in which three divided regions form one storage pixel.

The driving section 1019 applies clock signals to the 1st to 12th gate electrodes 2014 to 2036, thereby providing control to the operation of accumulating or transferring information charge. A 1st vertical clock signal ΦI201 is applied to the 1st gate electrode 2014, a 2nd vertical clock signal ΦI202 is applied to the 2nd gate electrode 2016, and a 3rd vertical clock signal ΦI203 is applied to the 3rd gate electrode 2018. A 4th vertical clock signal ΦI204 is applied to the 4th gate electrode 2020, a 5th vertical clock signal ΦI205 is applied to the 5th gate electrode 2022, and a 6th vertical clock signal ΦI206 is applied to the 6th gate electrode 2024. A 7th vertical clock signal ΦI207 is applied to the 7th gate electrode 2026, an 8th vertical clock signal ΦI208 is applied to the 8th gate electrode 2028, and a 9th vertical clock signal ΦI209 is applied to the 9th gate electrode 2030. A 1st storage clock signal ΦS201 is applied to the 10th gate electrode 2032, a 2nd storage clock signal ΦS202 is applied to the 11th gate electrode 2034, and a 3rd storage clock signal ΦS203 is applied to the 12th gate electrode 2036.

When the 1st to 9th vertical clock signals ΦI201 to ΦI209 become high in sequence, information charge is sequentially transferred in the order of the 1st to 9th gate electrodes 2014 to 2030, and meanwhile pixels are mixed. Furthermore, when the 1st to 3rd storage clock signals ΦS201 to ΦS203 become high, at least part of information charge is sequentially transferred in the order of the 10th to 12th gate electrodes 2032 to 2036.

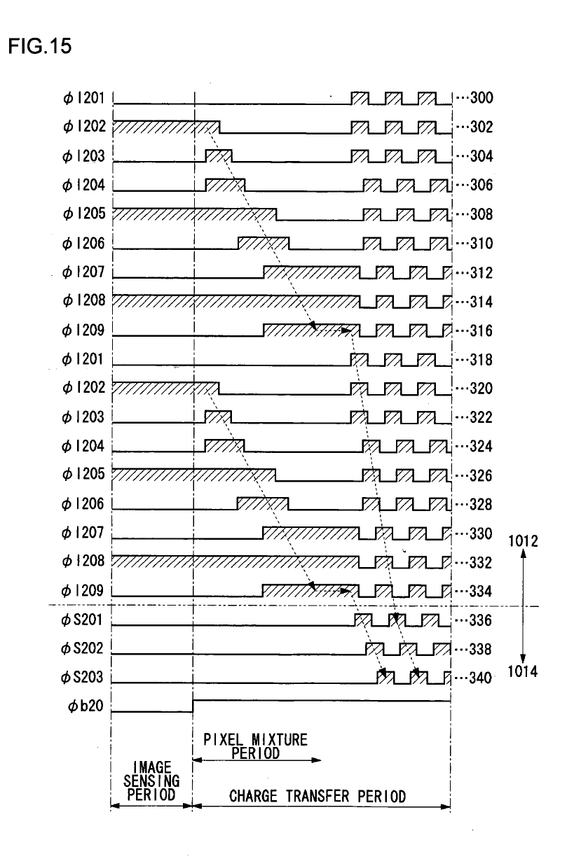

FIG. 15 is a time chart showing the process of information charge transfer according to the fourth embodiment. This figure shows the process of sequentially transferring information charge in the order of a plurality of vertically arranged divided-regions or 1st to 21st regions 300 to 340. The 1st to 18th regions 300 to 334 are part of the image sensing section 1012, and the 19th to 21st regions 336 to 340 are part of the storage section 1014. A chain double-dashed line between the 18th region 334 and the 19th region 336 is a boundary between the image sensing section 1012 and the storage section 1014.

The 1st vertical clock signal ΦI201 is applied to the 1st region 300 and the 10th region 318, the 2nd vertical clock signal ΦI202 is applied to the 2nd region 302 and the 11th region 320, and the 3rd vertical clock signal ΦI203 is applied to the 3rd region 304 and the 12th region 322. The 4th vertical clock signal ΦI204 is applied to the 4th region 306 and the 13th region 324, the 5th vertical clock signal ΦI205 is applied to the 5th region 308 and the 14th region 326, and the 6th vertical clock signal ΦI206 is applied to the 6th region 310 and the 15th region 328. The 7th vertical clock signal ΦI207 is applied to the 7th region 312 and the 16th region 330, the 8th vertical clock signal ΦI208 is applied to the 8th region 314 and the 17th region 332, and the 9th vertical clock signal ΦI209 is applied to the 9th region 316 and the 18th region 334. The 1st storage clock signal ΦS201 is applied to the 19th region 336, the 2nd storage clock signal ΦS202 is applied to the 20th region 338, and the 3rd storage clock signal ΦS203 is applied to the 21st region 340. The driving section 1019 applies, to the gate electrodes in respective regions, the 1st to 9th vertical clock signals ΦI201 to ΦI209 and the 1st to 3rd storage clock signals ΦS201 to ΦS203, respectively. The driving section 1019 also applies a substrate clock signal Φb20 to the drain region in each region.

The 1st region 300 to the 21st region 340 form one pixel every three regions, i.e., one for the 1st region 300 to the 3rd region 304, one for the 4th region 306 to the 6th region 310, one for the 7th region 312 to the 9th region 316, one for the 10th region 318 to the 12th region 322, one for the 13th region 324 to the 15th region 328, one for the 16th region 330 to the 18th region 334, and one for the 19th region 336 to the 21st region 340. In an image sensing period, an ON gate voltage is applied to the middle region one of the gate electrodes included in each three regions, while an OFF gate voltage is applied to the gate electrodes on both sides in the vertical direction. That is, in an image sensing period, the 2nd vertical clock signal ΦI202, the 5th vertical clock signal ΦI205, and the 8th vertical clock signal ΦI208 are made high, whereas the 1st vertical clock signal ΦI201, the 3rd vertical clock signal ΦI203, the 4th vertical clock signal ΦI204, the 6th vertical clock signal ΦI206, the 7th vertical clock signal ΦI207, and the 9th vertical clock signal ΦI209 are made low.

During a charge transfer period subsequent to the image sensing period, the 2nd vertical clock signal ΦI202, the 5th vertical clock signal ΦI205, and the 8th vertical clock signal ΦI208 remain high even after the image sensing period. When the 3rd vertical clock signal ΦI203 and the 4th vertical clock signal ΦI204 become high, the information charges in the 2nd region 302 and the 5th region 308 are mixed via the 3rd region 304 and the 4th region 306. While the 2nd vertical clock signal ΦI202 to the 4th vertical clock signal ΦI204 are being made low in sequence, the 6th vertical clock signal ΦI206 is made high as well as the 7th vertical clock signal ΦI207 and the 9th vertical clock signal ΦI209 are made high. When the 5th vertical clock signal ΦI205 and the 6th vertical clock signal ΦI206 are made low in sequence, the information charges move to the 7th region 312, the 8th region 314, and the 9th region 316 while being mixed. In this manner, pixels are mixed in the 2nd region 302, the 5th region 308, and the 8th region 314, thus the pixel mixture period being terminated in the charge transfer period.

Then, the 1st vertical clock signal ΦI201 to the 3rd vertical clock signal ΦI203 are made high, and the 7th vertical clock signal ΦI207 to the 9th vertical clock signal ΦI209 are made low. This causes the information charge sustained in the 7th region 312, the 8th region 314, and the 9th region 316 to move to the 10th region 318, the 11th region 320, and the 12th region 322. The 4th vertical clock signal ΦI204 to the 6th vertical clock signal ΦI206 are then made high and the 1st vertical clock signal ΦI201 to the 3rd vertical clock signal ΦI203 are made low. This causes the information charge sustained in the 10th region 318, the 11th region 320, and the 12th region 322 to move to the 13th region 324, the 14th region 326, and the 15th region 328. The 7th vertical clock signal ΦI207 to the 9th vertical clock signal ΦI209 are then made high and the 4th vertical clock signal ΦI204 to the 6th vertical clock signal ΦI206 are made low. This causes the information charge sustained in the 13th region 324, the 14th region 326, and the 15th region 328 to move to the 16th region 330, the 17th region 332, and the 18th region 334.

The 1st storage clock signal ΦS201 is then made high while the 7th vertical clock signal ΦI207 to the 9th vertical clock signal ΦI209 are made low. This causes at least part of the information charge sustained in the 16th region 330 to the 18th region 334 to move to the 19th region 336. The information charge that cannot be accommodated within the 19th region 336 is dumped to the substrate at the vicinity of the boundary between the 18th region 334 and the 19th region 336. When the 2nd storage clock signal ΦS202 is made high and the 1st storage clock signal ΦS201 is made low, the information charge in the 19th region 336 moves to the 20th region 338. When the 3rd storage clock signal ΦS203 is made high and the 2nd storage clock signal ΦS202 is made low, the information charge in the 20th region 338 moves to the 21st region 340.

During a charge transfer period subsequent to the image sensing period, the driving section 19 keeps the substrate clock signal Φb20 high which is applied to the drain region. As described above, even when pixels are mixed in the image sensing section 1012, the information charge that cannot be accommodated in the channel region underlying the gate of each pixel in the storage section 1014 is actively dumped toward the substrate. In particular, at the boundary between the image sensing section 1012 and the storage section 1014, information charge is actively dumped from the channel region toward the substrate, thereby preventing the information charge from leaking into the channel region of the other adjacent pixels. This makes it possible to prevent degradation of pixels which may be caused by information charge leaking into adjacent channel regions. The pixel mixture period in the charge transfer period may be excluded from the period during which the substrate clock signal Φb20 is kept high.

In the foregoing, the present invention has been described in accordance with the embodiments. These embodiments are given solely by way of illustration. It will be understood by those skilled in the art that various modifications may be made to combinations of the foregoing components and processes, and all such modifications are also intended to fall within the scope of the present invention. Now, descriptions are given to some modified examples.

In the first and second embodiments, such an arrangement has been shown in which the image sensing device of the present invention is used for transfer of information charge and pixel mixture in a plurality of pixels arranged in the order of red—green—red—green—red—green. In a modified example, however, the image sensing device of the present invention may also be used for charge transfer and pixel mixture in a plurality of pixels arranged in the order of blue—green—blue—green—blue—green. In this case, it is also possible to provide a good information charge transfer efficiency.

As shown in FIGS. 6 and 8, in the first and second embodiments, such an example has been described in which each transfer clock signal is made high to provide transfer control to pixels from which electrons have been purged during an image sensing period. However, a modified example may also be employed in which each transfer clock signal is allowed to remain low so as not to provide transfer control to pixels from which electrons have been purged during an image sensing period.

1. An image sensing device comprising:
an image sensing section which has a plurality of light-receiving pixels for converting incident light into information charge for storage during an image sensing period, the light-receiving pixels being disposed in rows and columns within a light-receiving region on a semiconductor substrate; and
a driving section which provides control such that information charge in at least one of the plurality of light-receiving pixels included in the image sensing section is dumped to the semiconductor substrate over an entire image sensing period, and that two or more of the plurality of light-receiving pixels are subjected to pixel mixture.

2. The image sensing device according to claim 1, wherein
the driving section provides control such that the pixel mixture occurs in the vicinity of the boundary between the image sensing section and a storage section.

3. The image sensing device according to claim 1, wherein
the driving section provides control such that the pixel mixture occurs within the image sensing section.

4. The image sensing device according to claim 1, further comprising a color filter provided on the image sensing section, wherein
a light-receiving pixel, corresponding to a particular color of the color filter, of the two or more light-receiving pixels serving as a unit of the pixel mixture converts incident light into information charge for storage during the image sensing period.

5. The image sensing device according to claim 1, wherein
any one of the two or more light-receiving pixels serving as a unit of the pixel mixture converts incident light into information charge for storage during the image sensing period.

6. A method for driving an image sensing device, comprising:
providing control such that information charge in at least one of a plurality of light-receiving pixels included in an image sensing section is dumped to a semiconductor substrate over an entire image sensing period; and
providing control such that two or more of the plurality of light-receiving pixels are subjected to pixel mixture.

7. An image sensing device comprising:
an image sensing section which has a plurality of light-receiving pixels for converting incident light into information charge for storage during an image sensing period, the light-receiving pixels being disposed within a light-receiving region on a semiconductor substrate;
a storage section which temporarily stores information charge which has been vertically transferred from the image sensing section; and
a transfer section which transfers the information charge stored in the storage section; wherein
a gate area of each pixel included in the storage section is formed to be grater than a gate area of each pixel included in the image sensing section.

8. The image sensing device according to claim 7 wherein
a gate length of each pixel included in the storage section is formed to be greater than a gate length of each pixel included in the image sensing device.

9. The image sensing device according to claim 7 further comprising a driving section which provides control to the image sensing section and the storage section such that pixels are to be mixed in the plurality of pixels during an information charge transfer period subsequent to the image sensing period, wherein
each of the plurality of light-receiving pixels disposed on a semiconductor substrate serving as the substrate is provided with a channel region for producing and accumulating information charge and a drain region adjacent to the channel region to absorb excess information charge, and
the driving section provides control such that a potential barrier formed during the transfer period between the channel region and the drain region is lower than a potential barrier formed during the image sensing period.

10. The image sensing device according to claim 9 wherein
the driving section provides control such that a voltage applied to the drain region is controlled, thereby to reduce the potential barrier.

11. The image sensing device according to claim 9 wherein
the driving section provides control such that an amount of output information charge during the transfer period is equal to an amount of output information charge provided when pixel mixture does not occur and no control is provided so as to reduce the potential barrier.

12. A method for driving an image sensing device comprising:
providing control such that incident light is converted into information charge for storage during an image sensing period,
providing control such that in an information charge transfer period subsequent to the image sensing period, a potential barrier formed between a channel region and a drain region is lower than a potential barrier formed during the image sensing period, the channel region producing and accumulating information charge in each of a plurality of light-receiving pixels, the drain region being adjacent to the channel region to absorb excess information charge, and
transferring information charge so that pixel mixture occurs in a plurality of pixels during the transfer period.
